(19) United States
(12) Patent Application Publication
(10) Pub. No.: US 2020/0018945 A1
(43) Pub. Date: Jan. 16, 2020

(54) LIGHT FIELD VISION, INFRARED ASSISTANCE AND IMAGING DEVICES

(71) Applicant: EVOLUTION OPTIKS LIMITED, Bridgetown (BB)

(72) Inventors: Daniel GOTSCH, Kingston (CA); Matej GOC, Kingston (CA); Joseph Ivar ETIGSON, Toronto (CA)

(21) Appl. No.: 16/510,529

(22) Filed: Jul. 12, 2019

(30) Foreign Application Priority Data
Jul. 16, 2018 (CA) 3011403

(51) Int. Cl. G02B 23/12; H04N 5/225

(52) U.S. Cl. CPC G02B 23/12; H04N 5/22541

(57) ABSTRACT

Described are various embodiments of a light field vision device for viewing an input scene in its field of view, comprising: an input light field optics layer to capture the input scene, said input light field optics layer comprising an array of optical structures projecting a corresponding array of input light field images therethrough representative of said input scene: a wavelength conversion layer disposed so as to have said light field images projected thereon and convert at least a portion thereof to a distinct optical wavelength to be emanated therefrom; and a converted light field optics layer comprising a corresponding array of optical structures disposed so to capture light emanating from said wavelength conversion layer to reconstruct corresponding wavelength-converted light-field images therefrom for viewing.

### CROSS REFERENCE TO RELATED APPLICATION

This application claims the benefit of priority to Canadian Patent Application No. 3,011,403, which was filed Jul. 16, 2018, and is incorporated herein by reference in its entirety and for all purposes.

### FIELD OF THE DISCLOSURE

The present disclosure relates to optical vision and imaging devices and, in particular, to a light field vision, infrared assistance and imaging devices.

### BACKGROUND

Different technologies enhance our ability to see beyond the natural limitations of the human eye, such as to view objects in difficult lighting conditions, such as low light conditions or if the light is in a spectral range beyond or toward the extremities of our natural perception.

For example, night vision goggles or cameras amplify light in low light conditions to a degree that can be perceived by the human eye. Other technologies may also help humans see in dark conditions. For example, thin films of photon conversion layers are able to absorb light at a given frequency (wavelength) and convert it to light at a higher or lower frequency. For example, acquiring near infrared (NIR) light and converting it to visible light may also enhance the ability of a person to see more clearly in limited or obscured ambient lighting conditions.

However, these systems and devices tend to be bulky and produce images of limited visual quality being generally limited to imaging the intensity of the incoming light without preserving any directional information otherwise available from the inbound light field. These devices can also suffer from other deficiencies, as will be readily apparent to the skilled artisan.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for light field vision and/or imaging devices, or night vision or IR-vision assistance devices, that overcome some of the drawbacks of known techniques, or at least, provides a useful alternative thereto. Some aspects of this disclosure provide examples of such devices.

For example, in accordance with some aspects, light field optics are combined with wavelength conversion materials to provide for the output of wavelength-converted light field images that can, in some examples, allow for efficient alternate wavelength vision and/or imaging while also preserving, to some extent, light field characteristics of an input optical scene or setting, which can optionally benefit downstream vision and/or image processing. For example, light field preserving night vision devices or goggles may be provided in some embodiments to produce enhanced night vision capabilities. Conversely, UV-to-visible conversions may allow for effective UV imaging or viewing in the visible spectrum without the use of dedicated UV sensors.

For example, in some embodiments, a compact solution may also be provided to improve upon otherwise commonly bulky form factors for night vision devices, for example, while in some embodiments, also benefiting from the above-noted light field preserving advantages.

Likewise, IR-assistance vision and/or imaging devices may be provided, for example, in combination with a digital image sensor and processor, to maintain light field information, enable/support image and/or vision correction applications, and/or integrate with other imaging and/or visions systems and devices, such as automotive systems and components (e.g. rear and/or side view cameras, mirrors, etc., IR-assisted windshield overlays and/or augmented reality interfaces, or the like). These and other such examples will be further detailed below.

As will be detailed further below, while light-field vision and imaging devices are described herein as preserving at least some of the directional information contained in an inbound light field representative of a particular scene or image, it will be appreciated that the terms “light field”, “light field image”, “light field data” or the like are to be construed broadly to encompass various forms not exclusively limited to the acquisition, processing, vision and/or rendering of full light field images, data, etc. For instance, these terms are used herein to refer to the acquisition, processing, vision and/or rendering of images captured and/or optically manipulated by optical element arrays, such as microlens arrays, that inherently produce an array a 2D images that at least partially encodes the inbound or input light field. These and other such considerations will be further detailed and exemplified below, as will be readily apparent to the skilled artisan.

In accordance with one aspect, there is provided a light field vision device for viewing an input scene in its field of view, comprising: an input light field optics layer to capture the input scene, said input light field optics layer comprising an array of optical structures projecting a corresponding array of input light field images therethrough representative of said input scene: a wavelength conversion layer disposed so as to have said light field images projected thereon and convert at least a portion thereof to a distinct optical wavelength to be emanated therefrom; and a converted light field optics layer comprising a corresponding array of optical structures disposed so to capture light emanating from said wavelength conversion layer to reconstruct corresponding wavelength-converted light-field images therefrom for viewing.

In one embodiment, the device further comprises a converted light field image channelling structure defined by an array of structural channels disposed relative to at least one of said input light field optics layer and said converted light field optics layer so as to coincide with said array of optical structures thereof.

In one embodiment, the device further comprises input and converted light field image channelling structures defined by respective arrays of structural channels respectively disposed relative to said input light field optics layer and said converted light field optics layer so as to coincide with each said array of optical structures.

In one embodiment, the input channelling structure is disposed one of upstream or downstream said input light field optics layer.

In one embodiment, the wavelength conversion layer comprises a photon up-conversion layer.

In one embodiment, the input light field images comprise infrared (IR) images and wherein said output wavelength-converted light-field images comprise visible images.

In one embodiment, the infrared images are near-IR (N-IR) images.

In one embodiment, the wavelength conversion layer comprises a photon down-conversion layer.

In one embodiment, the input light field images comprise ultraviolet (UV) images and wherein said output wavelength-converted light-field images comprise visible images.

In one embodiment, the device further comprises an output light field optics layer comprising a corresponding array of optical structures for conditioning said converted wavelength-converted light-field images for viewing.

In one embodiment, the device further comprises an optical diffuser disposed prior to said output light field optics layer so as to increase light uniformity incident thereupon.

In one embodiment, each of said optical structures comprises at least one of a microlens, a pinhole array, a Fresnel zone plate or an optical sieve.

In one embodiment, the device further comprises a digital sensor operable to acquire light field image data representative of said wavelength-converted light-field images; and a digital data processor operationally linked to said digital sensor and operable to process said light field image data and produce a viewable image therefrom.

In accordance with another aspect, there is provided a night vision device for viewing an input scene in its field of view, comprising: an infrared light field optics layer to capture the input scene, said input light field optics layer comprising an array of optical structures projecting a corresponding array of infrared (IR) or near-infrared (N-IR) input light field images therethrough representative of said input scene: a wavelength conversion layer disposed so as to have said input light field images projected thereon and convert at least a portion thereof to visible light to be emanated therefrom; and a visible light field optics layer comprising a corresponding array of optical structures disposed so to capture light emanating from said wavelength conversion layer to reconstruct corresponding visible light-field images therefrom for viewing.

In one embodiment, the device further comprises a visible light field image channelling structure defined by an array of structural channels disposed relative to at least one of said input light field optics layer and said visible light field optics layer so as to coincide with said array of optical structures thereof.

In one embodiment, the device further comprises infrared and visible light field image channelling structures defined by respective arrays of structural channels respectively disposed relative to said input light field optics layer and said visible light field optics layer so as to coincide with each said array of optical structures.

In one embodiment, the wavelength conversion layer comprises a photon up-conversion layer.

In one embodiment, the device further comprises an output light field optics layer comprising a corresponding array of optical structures for conditioning said visible light field images for viewing.

In one embodiment, the device further comprises an optical diffuser disposed prior to said output light field optics layer so as to increase light uniformity incident thereupon.

In one embodiment, each of said optical structures comprises at least one of a microlens, a pinhole array, a Fresnel zone plate or an optical sieve.

In accordance with another aspect, there is provided a light field imaging system for capturing an optical input, comprising: an input light field optics layer to capture said optical input and comprising an array of optical structures projecting a corresponding array of input light field images therethrough representative of said optical input: a wavelength conversion layer disposed so as to have said light field images projected thereon and convert at least a portion thereof to a distinct optical wavelength to be emanated therefrom; a converted light field optics layer comprising a corresponding array of optical structures disposed so to capture light emanating from said wavelength conversion layer to reconstruct corresponding wavelength-converted light-field images therefrom; a digital sensor operable to acquire light field image data representative of said wavelength-converted light-field images; and a digital data processor operationally linked to said digital sensor and operable to process said light field image data and produce a viewable image therefrom.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic representation of a light field vision device, in accordance with one embodiment;

FIGS. 2A and 2B are schematic representations of light field vision devices having light field image channelling structures, in accordance with other embodiments;

FIG. 3 is a schematic representation of a night vision device having light field image channelling structures and output visible light field conditioning optics, in accordance with another embodiment; and

FIGS. 4A and 4B are schematic representations of light field imaging devices, in accordance with other embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

The systems and methods described herein provide, in accordance with different embodiments, different examples of light field vision and/or imaging devices in which an input light field (i.e. inbound from a external scene or image within the field of view of the device) within a given input spectral range can be at least partially converted to a different spectral range to enhance or improve visibility and/or imaging, while in some embodiments, still preserving at least some of the directional information available within the input light field. For example, in some embodiments, an input light field is capture by an input light field optics layer that will project (i.e. relay, direct, etc.) a corresponding array of input light filed images therethrough to a wavelength conversion layer, which at least partially converts a wavelength thereof to a distinct optical wavelength to be emanated therefrom. Wavelength converted light emanating from this conversion layer is then captured by an output light field optics layer, and optional further optics and output processing elements, to be viewed, rendered or otherwise captured by a light field sensor or the like for further processing, etc.

For greater clarity, herein a light field is generally defined as a vector function that describes the amount of light flowing in every direction through every point in space, and in the described embodiments, will be associated with a particular scene or image to be viewed and/or imaged. In other words, anything that produces or reflects light will generally have an associated light field that, when combined and perceived (by the naked eye) or otherwise captured by a particular device, will contain all relevant optical information for a given scene within the viewers field of view. In the embodiments considered herein, light field information, which includes both optical intensity and directional information, will be further processed via a wavelength conversion element such that portions of the light field in a designated spectral range will be converted to a distinct spectral range. Accordingly, reference will be made herein to input, converted and output light fields and light field images to reflect optical changes applied to an originally captured scene and its associated light field when channeled through the various optical elements of the devices described herein.

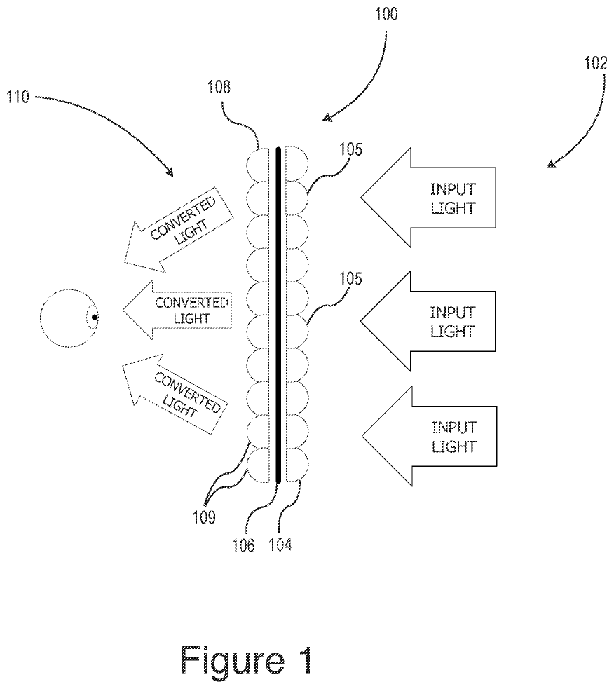

With reference to FIG. 1, and in accordance with one exemplary embodiment, a light field vision device for viewing an input scene in its field of view, generally referred to using the numeral 100, will now be described. In this exemplary embodiment, an incoming light field 102, representative of an external scene and consisting of light substantially of or within a first frequency or wavelength range, is incident upon an input light field optics layer 104 (e.g. light field shaping layer). This input light field optics layer generally comprises an array of optical structures or elements 105 projecting a corresponding array of input light field images therethrough representative of the input scene. A wavelength conversion layer 106 is disposed so as to have the light field images projected thereon and convert at least a portion thereof to a distinct optical wavelength to be emanated therefrom. A converted light field optics layer 108 comprising a corresponding array of optical structures 109 is disposed so to capture light emanating from the wavelength conversion layer to reconstruct corresponding wavelength-converted light field images 110 therefrom for viewing.

As will be further detailed below, arrayed optical elements or structures may include, but are not limited to, lenslets, microlenses or other such diffractive optical elements that together form, for example, a lenslet array; pinholes or like apertures or windows that together form, for example, a parallax or like barrier; concentrically patterned barriers, e.g. cut outs and/or windows, such as a to define a Fresnel zone plate or optical sieve, for example, and that together form a diffractive optical barrier (as described, for example, in Applicant's co-pending U.S. application Ser. No. 15/910,908, the entire contents of which are hereby incorporated herein by reference; and/or a combination thereof, such as for example, a lenslet array whose respective lenses or lenslets are partially shadowed or barriered around a periphery thereof so to combine the refractive properties of the lenslet with some of the advantages provided by a pinhole barrier. Herein, light field shaping will be understood by the person of ordinary skill in the art to reference measures by which light, that would otherwise emanate indiscriminately (i.e. isotropically) is deliberately controlled to define predictable light rays that can be traced between the focusing target and light source.

The wavelength (e.g. photon) conversion layer 106 is operable to convert at least a part of the light striking its surface into light of another wavelength or frequency. It may comprise a layer or film (or combination thereof) operable to absorb at least some light from an initial frequency or wavelength and convert at least a part of it to light at a substantially different frequency or wavelength via any frequency conversion mechanism. For example, the conversion of photons from a higher frequency to a lower frequency (e.g. ultraviolet light (UV) to visible light) is generally called down-conversion (DC) while converting lower frequency photons to higher frequency photons (e.g. infrared (IR) or near infrared (NIR) light to visible light) is similarly called up-conversion (UC). In some embodiments, such a layer may comprise one or more thin films of semiconducting materials or similar. For example, for up-converting NIR light to visible light, the layer may be comprised of an IR sensitive organic LED (IR-OLED), in which an OLED layer is combined with an IR sensitizing layer. In such a device, under IR irradiation, photo-generated holes in the IR sensitizing layer are injected into the emitting layer of the OLED and recombine with electrons injected from a cathode to emit light in the visible range. The IR sensitizing layer may be comprised of, but not limited to, organic semiconductor or inorganic semiconductor nanocrystals (NCs) thin films. For example, NIR conversion layers, such as that provided by nH2 Limited (Rowayton, Conn.), may comprise lead-sulphide nanocrystals, or quantum dots, arranged in a thin photo-sensitive layer that absorbs NIR light photons and release electrons that are themselves injected into an OLED layer to generate visible light. The layer can be readily assembled on a thin, flexible film, and the quantum dots fine tuned, for example, to absorb light with wavelengths between 0.35 and 2.2 microns. In these and similar examples, photon conversions may imply one-to-one photon conversions, or again, invoke amplification by external power input. The skilled technician will understand that different combinations or stacks of materials, and composition thereof may be used to tailor the spectral range of absorption/emission and conversion efficiency of such a film or layer. In some embodiments, the photon conversion layer may be at least partially transparent to the range of wavelengths or frequencies of the converted light, thereby emitting therefrom a superposition of light of at least two spectral ranges.

In the illustrated embodiment, the frequency-converted light generated from the wavelength/photon conversion layer is collected by another light field optics (e.g. shaping) layer 108, which shapes and projects it into a corresponding wavelength-converted light field. The construction parameters (i.e. dimensions, materials, focal distance, etc.) of layer 108 may be different from those of layer 104, due to the change in frequency or wavelength of the light it collects from the photon conversion layer 106. Moreover, it is expected that the change in frequency or wavelength of the converted light field still contains at least some, if not all the directional and intensity information of the initial input light field. As such, the light field shaping layer 108 is designed to produce an inverted image onto the eye of a user viewing the input light field with the herein described embodiment. In some embodiments, the converted light field may instead be projected onto a photographic film or digital camera sensor or similar. As discussed below, further processing may be applied to the converted light field output and/or further output conditioning optics may be applied depending on the application at hand and/or intended result.

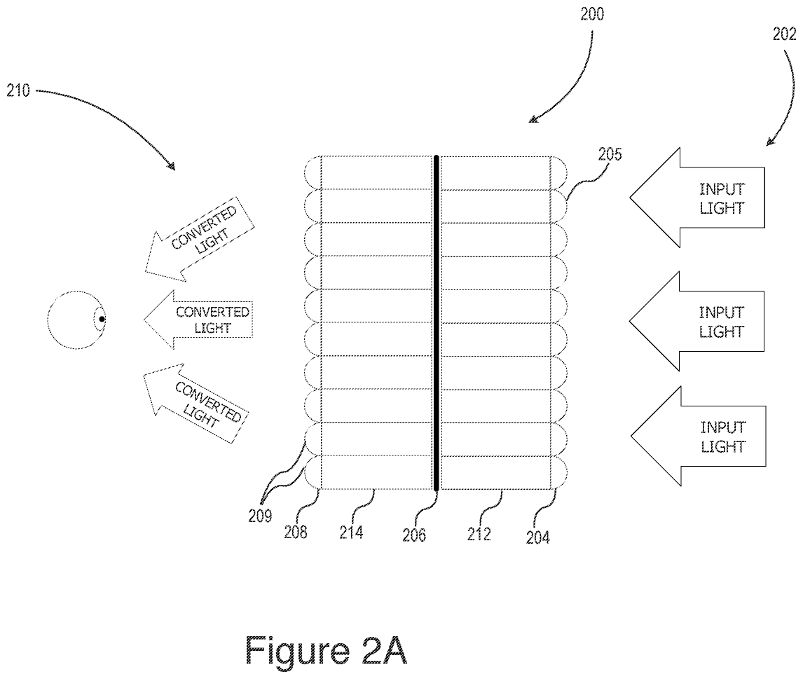

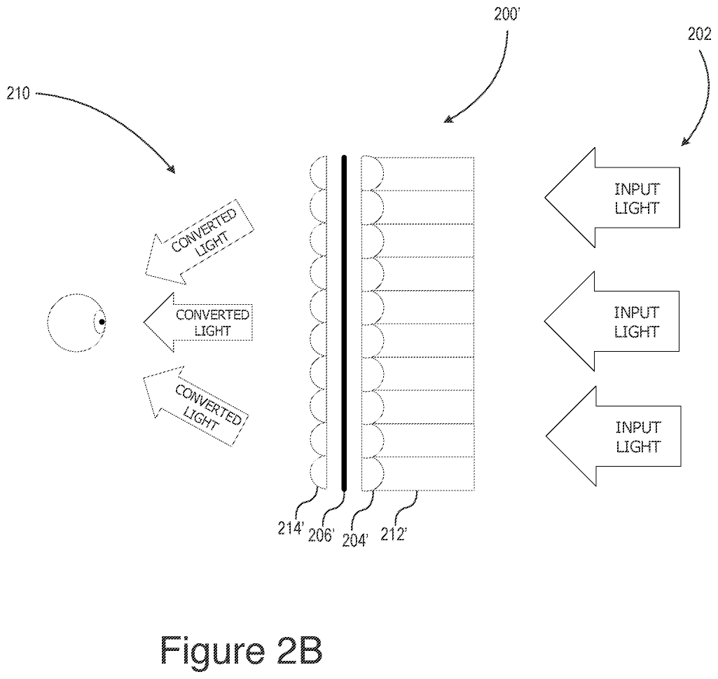

With reference to FIG. 2A, and in accordance with another exemplary embodiment, another light field vision device, generally referred to using the numeral 200, will now be described. In this exemplary embodiment, an incoming light field 202 representative of an external scene and consisting of light substantially of or within a first frequency or wavelength range, is again incident upon an input light field optics layer 204 (e.g. light field shaping layer). This input light field optics layer generally comprises an array of optical structures or elements 205 projecting a corresponding array of input light field images therethrough representative of the input scene. A wavelength conversion layer 206 is again disposed so as to have the light field images projected thereon and convert at least a portion thereof to a distinct optical wavelength to be emanated therefrom. A converted light field optics layer 208 comprising a corresponding array of optical structures 209 is again disposed so to capture light emanating from the wavelength conversion layer to reconstruct corresponding wavelength-converted light field images 210 therefrom for viewing.

In this embodiment, however, the device further comprises input and converted light field image channelling structures 212 and 214, respectively, defined by respective arrays of structural channels respectively disposed on either side of the wavelength conversion layer 206 so as to coincide with each array of optical structures, thereby delimiting corresponding wavelength conversion zones on the wavelength conversion layer from which to respectively reconstruct the wavelength-converted light-field images.

In one example, the structural channels may comprise an arrayed aperture or hollow tube-like structure (e.g. micro-tube structure) that together form a patterned barrier to be aligned with corresponding light field optics layer elements such that light corresponding to each light field channel is constrained from interfering or otherwise mixing with other channels. Accordingly, light rays corresponding to a given input and converted light field image will be constrained to its assigned channel and blocked from interfering with neighbouring channels. This may be of particular relevance in channelling converted light field images to the converted light field optics layer in the event that the wavelength conversion layer does not inherently preserve direction information during conversion, e.g. wherein converted light is generated and emanated randomly and/or omnidirectionally (as opposed to being redirected in a controlled and predictable fashion as would otherwise be the case with a standard lens or like geometrical optic element). Similarly, input channelling structures may prevent or reduce light from impacting different channels, for example, such as wide angle views/rays that could impact downstream sharpness, accuracy and/or resolution. Regardless, some embodiments may thus include only one light field channelling structure, for example, to channel input or converted light, rather than to include such structures on either side of the wavelength conversion element. Furthermore, while micro-channelling structures are illustratively disposed as being internal to the arrayed optical elements 204, 208, these may otherwise be disposed external thereto, e.g. wherein input light is first channeled by these ‘upstream’ structures before interfacing with the optical elements, as opposed to being channeled “downstream” therefrom. In yet other embodiments, a micro-channelling structure may be replaced with a single, albeit longer, or grouped, channelling tube(s), for example at the input, to reduce the impact of wide angle views. While doing so may reduce manufacturing complexity and costs, it would also impose a larger form factor for the device, which may be reasonable depending on the application at hand. The person of ordinary skill in the art will appreciate that different light field image channelling structures may be used and that, on one, the other or both sides of the wavelength conversion layer depending on the application at hand, the type of conversion taking place, and the level of image quality required depending on the application at hand.

In that respect, and in accordance with another exemplary embodiment, another light field vision device, generally referred to using the numeral 200′, is shown in FIG. 2B. In this exemplary embodiment, an incoming light field 202 representative of an external scene and consisting of light substantially of or within a first frequency or wavelength range, is first incident upon a micro-channel array 212′ before reaching the input light field optics layer 204′ (e.g. light field shaping layer). A wavelength conversion layer 206′ is again disposed so as to have the light field images projected thereon and convert at least a portion thereof to a distinct optical wavelength to be emanated therefrom. A converted light field optics layer 208′ is again disposed so to capture light emanating from the wavelength conversion layer to reconstruct corresponding wavelength-converted light field images 210 therefrom for viewing.

In some embodiments, the channelling (ray-blocking) structure may be made by drilling each aperture element within a polymer matrix or similar. In other embodiments, each aperture element may instead be fabricated from a refractive material, such as glass or silicon, which has a refractive index that is substantially different from the refractive index of the matrix material surrounding each element.

As noted above, in the illustrated embodiment, channelling structure 212 positioned between the first light shaping layer 204 and the photon conversion layer 206, is disposed so that each aperture element is aligned with only one light field shaping element from the adjacent light field shaping layer. Thus, the light entering each light field shaping elements is the only light channeled towards a corresponding surface section (zone) on the photon conversion layer 206.

Likewise, the channelling or ray-blocking layer 214 positioned on the other side of the photon conversion layer 206, is similarly disposed so as to align each aperture element with the aperture element of the first layer 212, so as to channel only converted light emitted by the corresponding surface section of the photon conversion layer 206 and blocking light from other adjacent sources. The converted light is thus channelled into each correspondingly aligned light field shaping element of the second light field shaping layer 208 to form a frequency-converted light field and thereby operable to focus an inverted image onto a user's eye, for example. As before, in some embodiments, the converted light field may instead be projected onto a photographic film or digital camera sensor or similar. In these cases, the acquired inverted image may be corrected with post-processing tools.

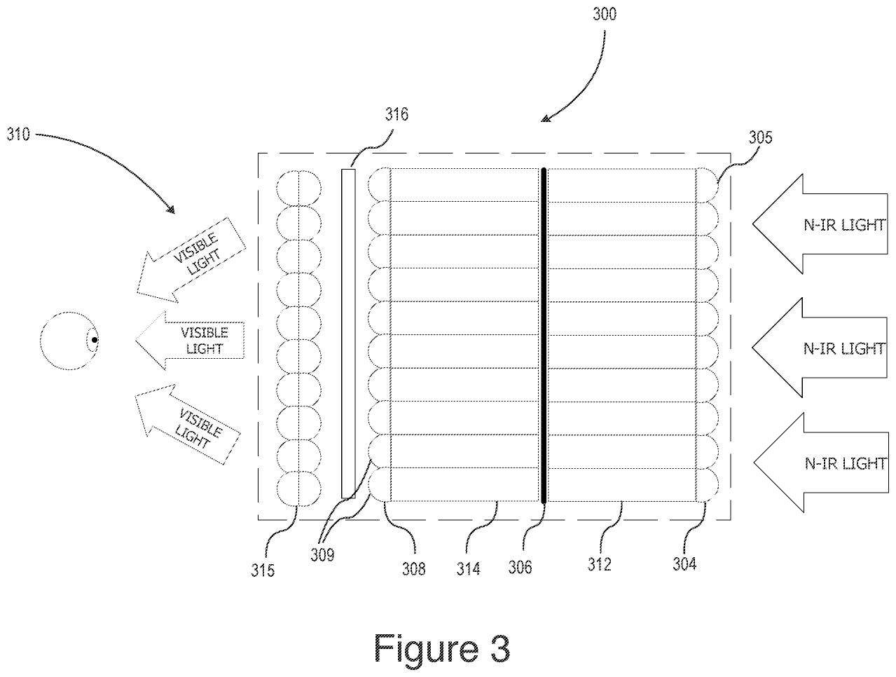

With reference to FIG. 3, and in accordance with another exemplary embodiment, a night vision device, generally referred to using the numeral 300, will now be described. In this exemplary embodiment, an incoming light field 302 representative of an external scene and consisting of light substantially of or within a first frequency or wavelength range (e.g. Near IR), is again incident upon an input (e.g. IR or NIR) light field optics layer 304 (e.g. light field shaping layer). This input light field optics layer generally comprises an array of optical structures or elements 305 projecting a corresponding array of input light field images therethrough representative of the input scene. A wavelength conversion layer 306, in this embodiment a photon up-converting layer, is again disposed so as to have the input light field images projected thereon and convert at least a portion thereof to a distinct optical wavelength to be emanated therefrom (e.g. visible light). A converted (e.g. visible) light field optics layer 308 comprising a corresponding array of optical structures 309 is again disposed so to capture light emanating from the wavelength conversion layer to reconstruct corresponding wavelength-converted light field images 310 therefrom for viewing.

In this embodiment, the device again further comprises input and converted light field image channelling structures 312 and 314, respectively, defined by respective arrays of structural channels respectively disposed on either side of the wavelength conversion layer 306 so as to coincide with each array of optical structures.

In this embodiment, however, the light field emerging from converted light field optics layer 308 is further conditioned by a conditioning (shaping) light field optics layer 315, positioned to receive the converted light field and, in one example, correcting for the inversion thereof, and in some examples, engineered to focus it into a user's eye, or in other embodiments, a photographic film or digital camera sensor. Furthermore, in some embodiments, an additional optical diffuser or image intensifier 316 may also be used, between said converted and conditioning light field optics layers, for providing a more uniform light source for the conditioning light field optics layer and thus improve image quality.

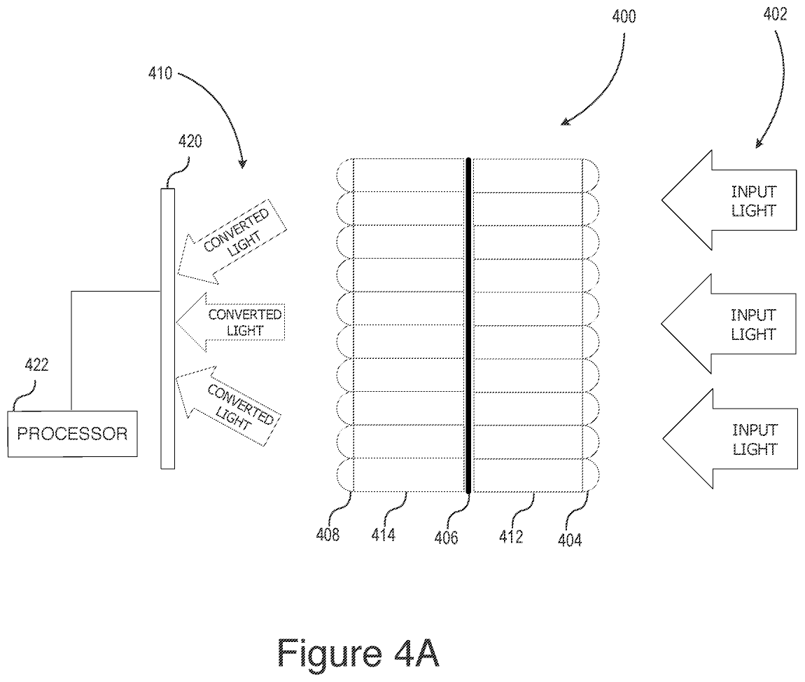

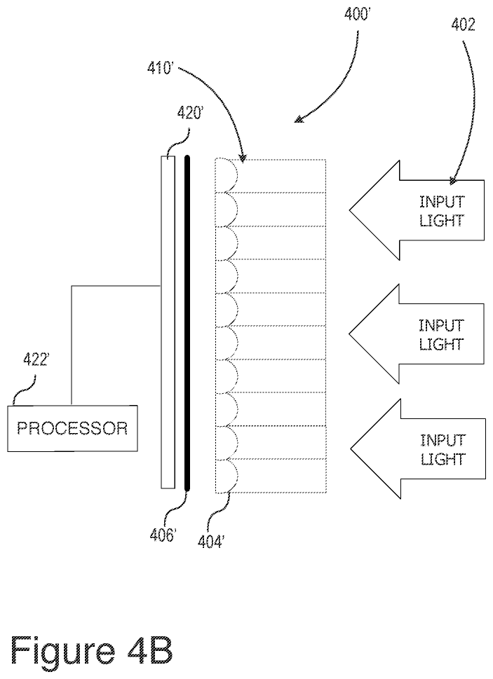

With reference to FIG. 4A, and in accordance with another exemplary embodiment, a light field imaging device, generally referred to using the numeral 400, will now be described. In this exemplary embodiment, an incoming light field 402 representative of an external scene and consisting of light substantially of or within a first frequency or wavelength range, is again incident upon an input light field optics layer 404 (e.g. light field shaping layer). A wavelength conversion layer 406 is again disposed so as to have the input light field images projected thereon and convert at least a portion thereof to a distinct optical wavelength to be emanated therefrom. A converted light field optics layer 408 comprising a corresponding array of optical structures 409 is again disposed so to capture light emanating from the wavelength conversion layer to reconstruct corresponding wavelength-converted light field images 410 therefrom.

In this embodiment, the device again further comprises input and converted light field image channelling structures 412 and 414, respectively, defined by respective arrays of structural channels respectively disposed on either side of the wavelength conversion layer 406 so as to coincide with each array of optical structures. In this embodiment, the device 400 further comprises a digital sensor 420 operable to acquire light field image data representative of the wavelength-converted light-field images and relay this data to a digital data processor 422 operationally linked thereto for further processing and/or rendering.

In yet another illustrative embodiment, as shown for example in FIG. 4B, a similar device 400′ receives input light 402 via a micro-channel array 410′ before interfacing with the input optics layer 404′ and conversion layer 406′. Converted light is then directed to the digital sensor 420′ which is operable to acquire light field image data, that is to generally acquire an array of 2D images effectively encoding the light-field through wavelength-converted images and relay this data to a digital data processor 422′ operationally linked thereto for further processing and/or rendering.

In these examples, captured and converted IR-imaging data can be relayed and processed for downstream applications, such as in the context of various medical, industrial and/or automotive applications, for example. For instance, in the automotive industry, the IR-converted light field data can be processed and rendered for viewing within the context of a rear or side view device, for example, whereby IR-enhanced images captured by a device as described herein can be converted and rendered on a digital screen strategically disposed within the vehicle. In one such example, IR-enhanced images can be processed within the context of a backing-up rear-view camera used when a vehicle is operated in reverse. In this case, a device as in FIG. 4 could be installed or otherwise disposed on the rear of the vehicle and used to capture relevant data therefrom. In other examples, such data could be captured by side view cameras to enhance or replace side view mirrors. Likewise, rear view mirrors could be replaced and/or enhanced accordingly.

To follow from these examples, it will be appreciated that where optical imaging is contained to IR-image conversion or enhancement, all-optical solutions may be deployed (i.e. other than possible external power input optical up-conversion and/or amplification) in an analogue system to produce desirable results. For example, a layered all-optical architecture as described above with reference to FIGS. 1 to 3 could be applied to provide IR-enhancements (e.g. for direct viewing and/or via an intermediary or redirecting optics such as one or a combination of output filters, lenses, mirrors, diffusers and/or the like.

In other solutions, wherein a digital image sensor is invoked to process the converted light-field data, further image processing may be invoked to achieve a desired result. For example, where fundamental optical properties result in an inverted image, digital image processing may be invoked to create the appropriate inversion. Other image processing filters may include colour rendering changes or enhancements, image sharpening, etc.

Furthermore, where light field data is adequately preserved, image focusing or refocusing can be implemented digitally by leveraging the power of the enhanced stored light field information. This may be particularly helpful in the context of automotive solutions where always in focus requirements may be applied.

In yet other examples, further vision correction applications may be applied, for example as described in co-pending U.S. patent application Ser. Nos. 15/246,255 and 15/910,908, and in co-pending Canadian Patent Application Nos. 2,997,883; 2,997,884; and 2,997,885, the entire contents of each of which are hereby incorporated herein by reference, in which a digital image captured or enhanced by embodiments as described herein can be further manipulated to implement vision correction consistent with an operator and/or passenger of the vehicle. For instance, such vision correction applications may allow, in some examples, an operator that would otherwise require vision correcting glasses to operate the vehicle without them.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A light field vision device for viewing an input scene in its field of view, comprising:
an input light field optics layer to capture the input scene, said input light field optics layer comprising an array of optical structures projecting a corresponding array of input light field images therethrough representative of said input scene:
a wavelength conversion layer disposed so as to have said light field images projected thereon and convert at least a portion thereof to a distinct optical wavelength to be emanated therefrom; and
a converted light field optics layer comprising a corresponding array of optical structures disposed so to capture light emanating from said wavelength conversion layer to reconstruct corresponding wavelength-converted light-field images therefrom for viewing.

2. The device of claim 1, further comprising:
a converted light field image channelling structure defined by an array of structural channels disposed relative to at least one of said input light field optics layer and said converted light field optics layer so as to coincide with said array of optical structures thereof.

3. The device of claim 1, further comprising:
input and converted light field image channelling structures defined by respective arrays of structural channels respectively disposed relative to said input light field optics layer and said converted light field optics layer so as to coincide with each said array of optical structures.

4. The device of claim 2, wherein said input channelling structure is disposed one of upstream or downstream said input light field optics layer.

5. The device of claim 1, wherein said wavelength conversion layer comprises a photon up-conversion layer.

6. The device of claim 5, wherein said input light field images comprise infrared (IR) or near-IR (N-IR) images, and wherein said output wavelength-converted light-field images comprise visible images.

7. The device of claim 1, wherein said wavelength conversion layer comprises a photon down-conversion layer.

8. The device of claim 7, wherein said input light field images comprise ultraviolet (UV) images and wherein said output wavelength-converted light-field images comprise visible images.

9. The device of claim 1, further comprising an output light field optics layer comprising a corresponding array of optical structures for conditioning said converted wavelength-converted light-field images for viewing.

10. The device of claim 9, further comprising an optical diffuser disposed prior to said output light field optics layer so as to increase light uniformity incident thereupon.

11. The device of claim 1, wherein each of said optical structures comprises at least one of a microlens, a pinhole array, a Fresnel zone plate or an optical sieve.

12. The device of claim 1, further comprising:
a digital sensor operable to acquire light field image data representative of said wavelength-converted light-field images; and
a digital data processor operationally linked to said digital sensor and operable to process said light field image data and produce a viewable image therefrom.

13. A night vision device for viewing an input scene in its field of view, comprising:
an infrared light field optics layer to capture the input scene, said input light field optics layer comprising an array of optical structures projecting a corresponding array of infrared (IR) or near-infrared (N-IR) input light field images therethrough representative of said input scene:
a wavelength conversion layer disposed so as to have said input light field images projected thereon and convert at least a portion thereof to visible light to be emanated therefrom; and
a visible light field optics layer comprising a corresponding array of optical structures disposed so to capture light emanating from said wavelength conversion layer to reconstruct corresponding visible light-field images therefrom for viewing.

14. The device of claim 13, further comprising:
a visible light field image channelling structure defined by an array of structural channels disposed relative to at least one of said input light field optics layer and said visible light field optics layer so as to coincide with said array of optical structures thereof.

15. The device of claim 13, further comprising:
infrared and visible light field image channelling structures defined by respective arrays of structural channels respectively disposed relative to said input light field optics layer and said visible light field optics layer so as to coincide with each said array of optical structures.

16. The device of claim 1, wherein said wavelength conversion layer comprises a photon up-conversion layer.

17. The device of claim 14, further comprising an output light field optics layer comprising a corresponding array of optical structures for conditioning said visible light field images for viewing.

18. The device of claim 17, further comprising an optical diffuser disposed prior to said output light field optics layer so as to increase light uniformity incident thereupon.

19. The device of claim 14, wherein each of said optical structures comprises at least one of a microlens, a pinhole array, a Fresnel zone plate or an optical sieve.

20. A light field imaging system for capturing an optical input, comprising:
an input light field optics layer to capture said optical input and comprising an array of optical structures projecting a corresponding array of input light field images therethrough representative of said optical input:
a wavelength conversion layer disposed so as to have said light field images projected thereon and convert at least a portion thereof to a distinct optical wavelength to be emanated therefrom;
a converted light field optics layer comprising a corresponding array of optical structures disposed so to capture light emanating from said wavelength conversion layer to reconstruct corresponding wavelength-converted light-field images therefrom
a digital sensor operable to acquire light field image data representative of said wavelength-converted light-field images; and
a digital data processor operationally linked to said digital sensor and operable to process said light field image data and produce a viewable image therefrom.
